(19) United States
(12) Patent Application Publication
(10) Pub. No.: US 2007/0088844 A1
(43) Pub. Date: Apr. 19, 2007

(54) System for and method of extracting a time-based portion of media and serving it over the Web

(75) Inventor: Josh Seims, San Francisco, CA (US)

Correspondence Address: Jonathan O. Owens;HAVERSTOCK & OWENS LLP, 162 North Wolfe Road, Sunnyvale, CA, 94086, US

(73) Assignee: Meta Interfaces, LLC, San Francisco, CA (US)

(21) Appl. No.: 11/445,628

(22) Filed: Jun. 2, 2006

Related U.S. Application Data
(60) Provisional application No. 60/688,143, filed on Jun. 7, 2005.

(51) Int. Cl. G06F 15/16

(52) U.S. Cl. 709/231

(57) ABSTRACT

Methods of and systems for serving media are disclosed. One method includes selecting a segment of a block of media data, formatting a data package containing the selected segment for playing on a media player, and transmitting the data package to a client system. Preferably, the transmission forms streaming video data, which can later be played on a client system using a media player. In one embodiment, thumbnails of video frames from the block of media data are presented to a user, who then selects a beginning frame and an end frame that together define the selected segment, which is then streamed to the user or is downloaded for later playback. Preferably, the data package is formatted according to Advanced Systems Format and transmitted to the client system according to HyperText Transfer Protocol. In some embodiments, the selected video clip can be stored on the client system and indexed so that it can be searched against and played at a later time.

### RELATED APPLICATION

This application claims priority under 35 U.S.C. § 119(e) of the co-pending U.S. provisional patent application Ser. No. 60/688,143, filed Jun. 8, 2005, and titled “Method and Apparatus to Extract a Time-Based Portion of a Video and Serve it Over the Web,” which is hereby incorporated by reference.

### FIELD OF THE INVENTION

The present invention relates to data processing systems and methods. More specifically, the present invention relates to systems for and methods of selecting a portion of media data for later playback.

### BACKGROUND OF THE INVENTION

A conventional media system is a system that provides architectures for users to access media content, including audio, video, and animation, over the Web and enjoy the media content on a client system. These media systems include, for example, a server for storing and transmitting the media to the client system, which includes a media player. These media systems are configured either to stream media to the client system so that the user can play it immediately, or to download the media to the client system for later playback.

U.S. Pat. No. 6,041,345, entitled “Active Stream Format For Holding Multiple Media Streams,” to Levi et al. (Levi Patent), explains a container format used for encapsulating multiple data streams. The data streams may be of different media. The data of the data streams are partitioned into packets that are suitable for transmission over a transport medium. The container format is Microsoft's Advanced Systems Format (ASF) Specification. The format of ASF facilitates flexibility and choice of packet size and in specifying maximum bit rate at which data may be rendered. The format facilitates dynamic definition of media types and the packetization of data in such dynamically defined data types within the format.

However, the Levi Patent is not directed toward methods of downloading streaming media. Broadly speaking, the Levi Patent does describe methods of enhancing the experience of viewing and listening to streaming media on a client system.

Unfortunately, conventional media systems have drawbacks, especially if the user wants to see only a segment of a video or other media file. For example, downloading the entire video file when the user wants to view only a segment is inefficient. It takes up unnecessary bandwidth, adds to the load on both the server and the client system on which the video file is stored or played. And because the entire file is downloaded, the user must wait a relatively longer time to view it. This can be noticeable for large media files, such as a full-length movie file.

Streaming the video file has inherent disadvantages. For example, the user must view or fast-forward to the beginning of the segment the user wants to watch. For long video files, such as full-length movies, the user often has to perform a seek operation several times in order to find the segment the user wants to watch. Unfortunately, each seek operation causes a delay while the video stream re-buffers. Further, conventional streaming protocols do not allow the user to store the video stream to his local client system.

### SUMMARY OF THE INVENTION

In a first aspect of the present invention, a method of serving media includes selecting a segment of a block of media data, formatting a data package containing the selected segment for playing on a media player, and transmitting the data package to a client system. Preferably, the transmission of the data package forms streaming media. The method also includes playing the data package on a media player on the client system. In one embodiment, the data package is formatted according to Advanced Systems Format.

Preferably, the data package is transmitted to the client system according to HyperText Transfer Protocol, but it can also be transmitted using Real Time Streaming Protocol or some other protocol. The block of media data corresponds to audio data, video data, audio/video data, animation data, or any other type of data.

In one embodiment, the segment of the block of media data is selected by selecting start and end frames from the block of media, such as by using a graphical user interface. In another embodiment, the method also includes determining a cost of transmitting the data package. The cost is based on a size of the selected segment, a relation between a size of the selected segment and a size of the block of media data, or any other pricing method.

In a second aspect of the present invention, a method of managing media data includes selecting a segment from a block of media data, formatting a data package containing the segment for playing on a media player, and storing the data package on a client system. The data package is formatted by generating a header corresponding to the selected segment. The header includes metadata, such as a title, an artist, a movie classification, a song classification, or any combination of these. Preferably, the data package is formatted using Advanced Systems Format.

The method also includes performing a search for the formatted data package based on at least a portion of the metadata.

In a third aspect of the present invention, a system for processing media data includes a server and a client system. The server is for selecting a segment of a block of media data, encapsulating the selected data segment, and transmitting the encapsulated data segment over a transmission medium. The client system is for receiving and playing the encapsulated data segment and includes a media player, such as an audio/video player or an audio player, to name a few media players. The client system also includes a Web browser for communicating with the server for selecting and transmitting the segment.

The server includes a presentation module and a selection module. The presentation module is for presenting a list of media files, such as movies, concerts, real-time sporting events, and the like. The presentation module allows a user to select one media file, such as a movie, from the list. The selection module allows the user to select a segment of the movie, for viewing or later download, such as by selecting from multiple video frames a start video frame that defines the start of the segment and an end video frame that defines the end of the segment.

In one embodiment, the media data are audio/video data and each of the multiple frames is a thumbnail video frame. In another embodiment, the media data are any one of video data, audio data, and animation data. Preferably, the presentation module and the selection module both include or form part of the same graphical user interface. The selection module is configured to select the start and end frames using drag-and-drop, a radio button, or any other selection means.

Preferably, the server and the client system are configured to communicate according to HyperText Transfer Protocol, and the server is configured to encapsulate the selected data segment according to Advanced Systems Format.

In a fourth aspect of the present invention, a system for processing media data includes means for selecting a segment of a block of media data, means for encapsulating the selected data segment, and means for transmitting the encapsulated data segment over a transmission medium to a client system configured to receive and play the encapsulated data segment.

In a fifth aspect of the present invention, a computer-readable medium has computer executable instructions for performing a method. The method includes selecting a segment of a media block and formatting a data packet containing the selected segment for playing on a media player. The method also includes sending the formatted data packet over a transmission medium to a client system.

### BRIEF DESCRIPTION OF THE DRAWINGS

FIG. 1 shows a sequence of video frames from digital video media.

FIG. 2 shows the sequence of video frames from FIG. 1 and a control area for selecting starting and ending frames to define a video clip for viewing in accordance with one embodiment of the present invention.

FIG. 3 shows the sequence of video frames and the control area, both from FIG. 2, after a user has selected starting and ending frames in accordance with one embodiment of the present invention.

FIG. 4 shows the sequence of video frames and the control area, both from FIG. 2, after a user has selected starting and ending frames in accordance with another embodiment of the present invention.

FIG. 5 shows video frames from the selected segment of video data shown in FIG. 3 accordance with the present invention.

FIG. 6 shows a generic container for encapsulating the selected segment of video data for storage or transmission to a client system in accordance with one embodiment of the present invention.

FIG. 7 is a flow chart of steps for formatting a data package containing the selected segment of video data shown in FIG. 5.

FIG. 8 is a container for encapsulating a selected segment of video data according to the Advanced Systems Format.

FIG. 9 is a library directory used to store, retrieve, and search for segments of video data selected and packaged in accordance with the present invention.

FIG. 10 shows components of a system for selecting and transmitting selected segments of video data to a client system in accordance with the present invention.

### DETAILED DESCRIPTION OF THE PREFERRED EMBODIMENTS

Systems and methods in accordance with the present invention allow a user to select a segment of media data, such as a video or sound clip, from a media file. The extracted segment can then be stored, played, downloaded to another computer for later storage or playback, or streamed to another computer for immediate playing. The media data can be any type of data for sequential playing, such as audio/video data including movies, television shows, and live events; audio events, such as music albums stored on compact discs; and animation sequences.

As one example, the media data is already hosted on a server as audio/video data for a three-hour movie. A user on a client system wishes to view only a small segment (a video clip) of the movie on a media player on the client system. To select the start and end times of the segment, the user is presented with still frames from the movie. The user selects a start frame marking the start of the video clip and an end frame marking the end of the video clip and then initiates a transmission of the video clip from the server to the client system as streaming media. Once a pre-determined portion of the video clip is on the client system, the user can play it using the media player or save it.

Using the present invention, a user can thus extract and watch a video clip of only the big fight scene in a full-length movie or only the winning play in a 3-hour football game. The media data are audio/video data and each of the multiple frames can be referred to as a thumbnail video frame.

The present invention applies even if the resulting media is only streamed, instead of being first stored locally on the client system. In other words, an embodiment of the present invention includes streaming a video segment directly from a host server, rather than storing the video segment locally first.

The present invention provides many advantages. For example, downloading small media segments rather than an entire media data file reduces bandwidth requirements and the loads on both a server and a client system. In some embodiments of the present invention, a customer is charged a fee based on the size of the selected media segment. Because the customer generally pays less for the selected segment than for the entire video file, much of which the user will not watch, the user pays only for what the user will use. The user is therefore more likely to use a fee-based media library that allows him to select and later view video clips for a correspondingly smaller fee.

Once the media segments are stored on a client system, they can be easily searched using information stored as part of the media segment. This “metadata” can include a title, an actor name, a performer name, and a date that the segment was saved on the client system, to name a few search criteria.

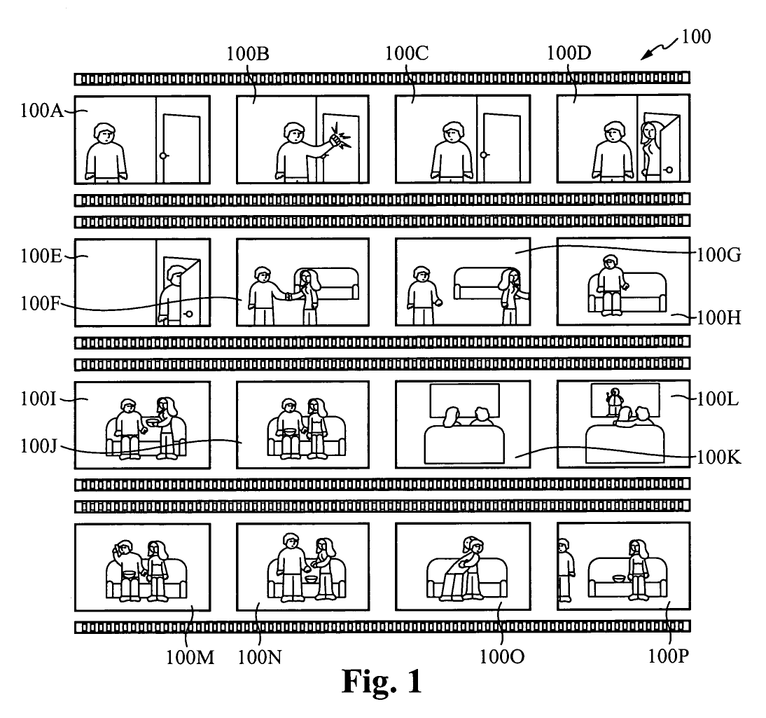

FIG. 1 shows a time-based sequence of video frames 100A-100P. When displayed sequentially, the video frames 100A-P are seen as a seamless moving picture. Each frame is also represented by a digital representation (a digital video frame) from which a media player (here, a video player) renders the frame for viewing. When the video player sequentially processes the digital frames, the corresponding moving picture is displayed on the video player. Each sequence of digital video frames has a corresponding sequence of audio frames that compose the “sound track” for the movie. To simplify the discussion that follows, reference to a video frame or video data refers to a video frame or the combination of an audio and video frame. Those skilled in the art will recognize from the context of the discussion when the video frame is combined with an audio frame for presentation to a user.

Those skilled in the art will also recognize that digital media is generally encoded for storage and transmission and then decoded to recover the presentation presented when the digital media is played. This encoding and decoding, performed by a component called a “codec,” can be based on any format such as Motion Picture Experts Group versions 1, 2, or 4 (MPEG-1, MPEG-2, MPEG-4), H.261, H.263, Windows Media Video, Window's Media Format (WMF), and Real Video, to name only a few. Those skilled in the art will recognize that references to media data packaged for transmission are to encoded media data.

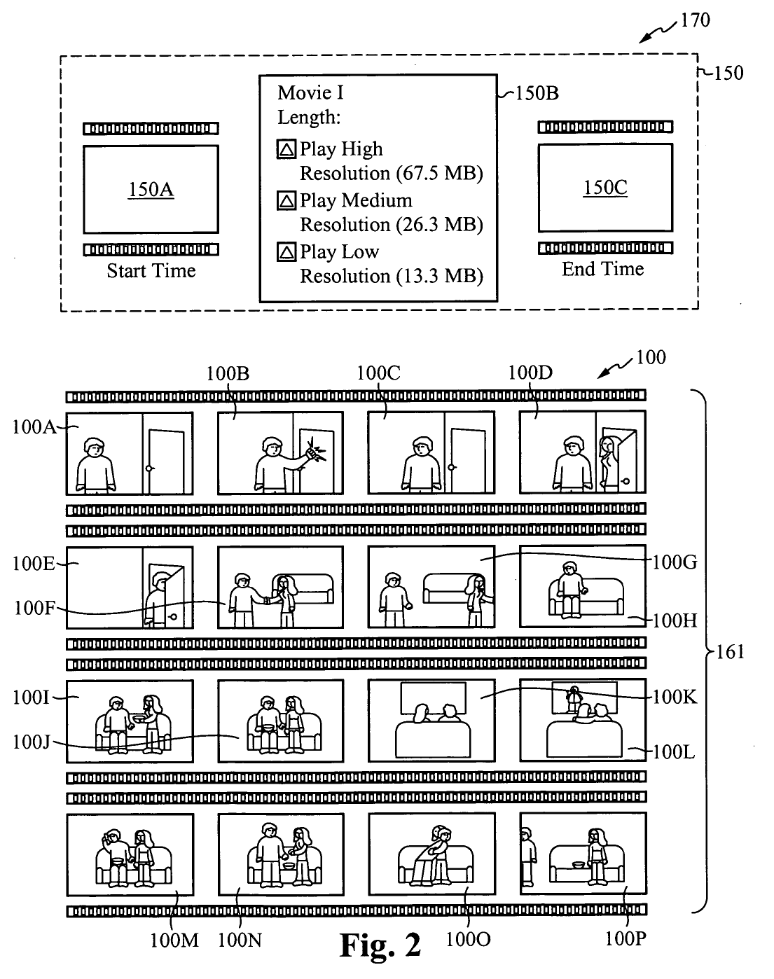

FIG. 2 shows a graphical user interface (GUI) 170 presented to a user for selecting a segment of a video. The GUI 170 includes a frame display section 161 and a control section 150. The frame display section 161 displays a sequence of video frames selected from the sequence of video frames 100 shown in FIG. 1. Throughout this and the following descriptions, the same reference numbers refer to identical elements. It will be appreciated that while the frame display section 161 is shown including all of the video frames from the sequence of video frames 100, generally the frame display section 161 will include only a small fraction of the sequence of video frames 100. As one example, the sequence of video frames 100 includes 70,000 video frames and the frame display section 161 includes every 500th frame from the 70,000 video frames, or 140 video frames. Using the control section 150, the user is able to select a video clip beginning 1 hour and 15 minutes from the start of the movie and ending 1 hour 25 minutes from the start of the movie. If, for example, there are 30 frames per second, this time range is represented by the sequence of video frames from frame 135,000 to frame 153,000.

By giving a snapshot of the video frames spaced at appropriate time intervals, the user is able to select the beginning and end times of the video clip. In one embodiment of the present invention, a user is able to tune the coarseness of the frame display section, that is, the time difference between the video frames displayed in the frame display section 161. For example, a user is able to select that video frames are displayed for every 6th video frame in the sequence, that is, for a frame rate of 30 frames per second, in one-second increments. Alternatively, the user is able to select that video frames are displayed from the movie in one-minute increments. The user can select the coarseness to help him find recognizable markers for finding the starting and ending frames of the video clip.

The control section 150 includes an area 150A to receive a user-selected start frame marking the start of the video clip and an area 150C to receive a user-selected end frame marking the end of the video clip. Once a movie has been selected from which the vide clip is to be extracted, the title of the movie shown in the sequence of video frames 100A-P (“Movie I”) is displayed in the control section 150B. The control section 150B also displays controls for selecting the resolution for playing the video clip, here, “High,” “Medium,” and “Low.”

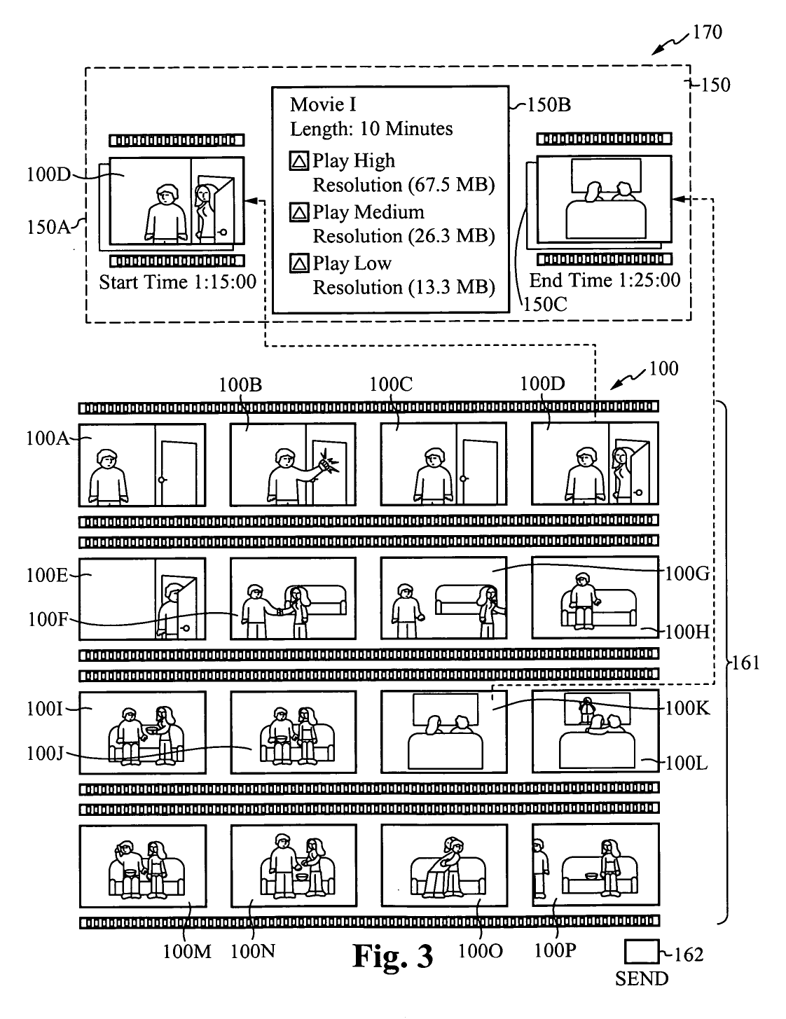

FIG. 3 shows the GUI 170 after a user has selected the video frame 100D as the starting frame and the video frame 100K as the ending frame, as shown by the dashed arrow connecting the video frame 100D to the area 150A and the dashed arrow connecting the video frame 100K to the area 150C. In the embodiment shown in FIG. 3, the video frames 100D and 100K are dragged and dropped to the areas 150A and 150C, respectively. By selecting the Send button 162, the user can now send the selected video clip to a client system for playing or storing.

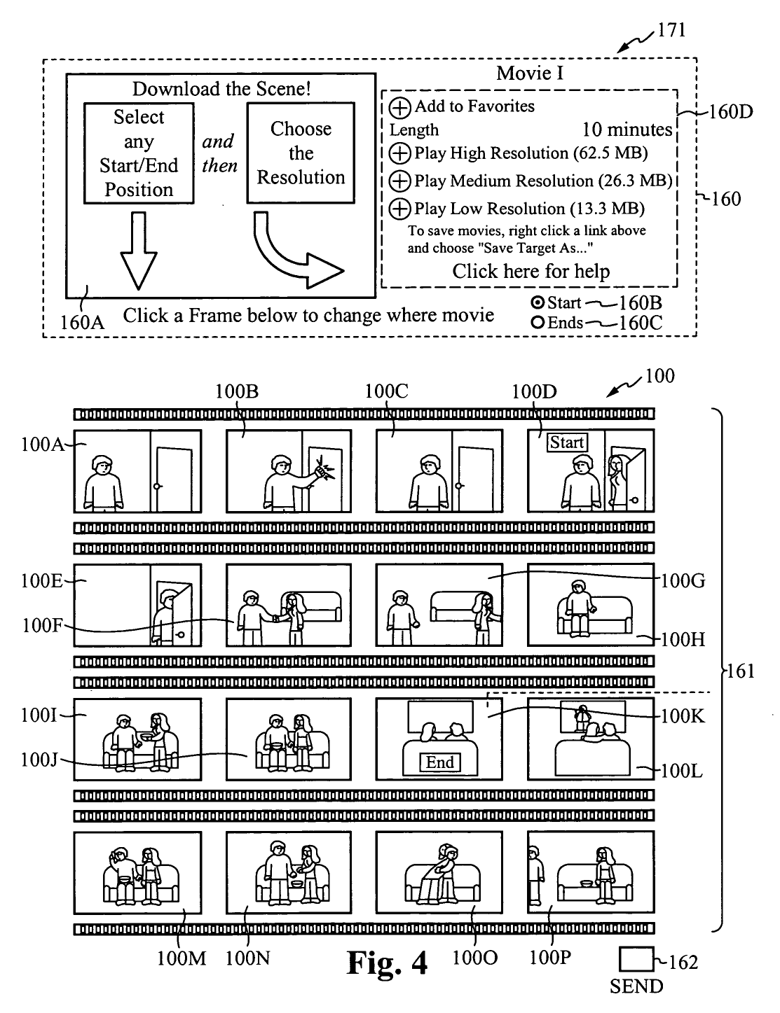

FIG. 4 shows a GUI 171 with a control section 160 for selecting a video clip using radio buttons instead of drag-and-drop. The control section 160 includes a direction box 160A, explaining how to use the GUI 171, and a control area 160B for adding the video clip to a library and for determining the resolution for playing the video clip. In the example shown in FIG. 4, a user has placed a cursor over video frame 100D and selected the “Starts” radio button 160B and then placed the cursor over the video frame 100K and selected the “Ends” radio button 160C, thereby selecting the video clip beginning at the video frame 100D and ending at the video frame 100K.

The present invention can be carried out even if the selection interface uses neither “drag and drop” nor “radio button” check boxes. “Drag and drop” is discussed above with reference to FIG. 3. “Radio button” check boxes are discussed above with reference to FIG. 4. These features are preferably incidental to a preferred graphical user interface. However, they do not affect the primary functionality of the present invention.

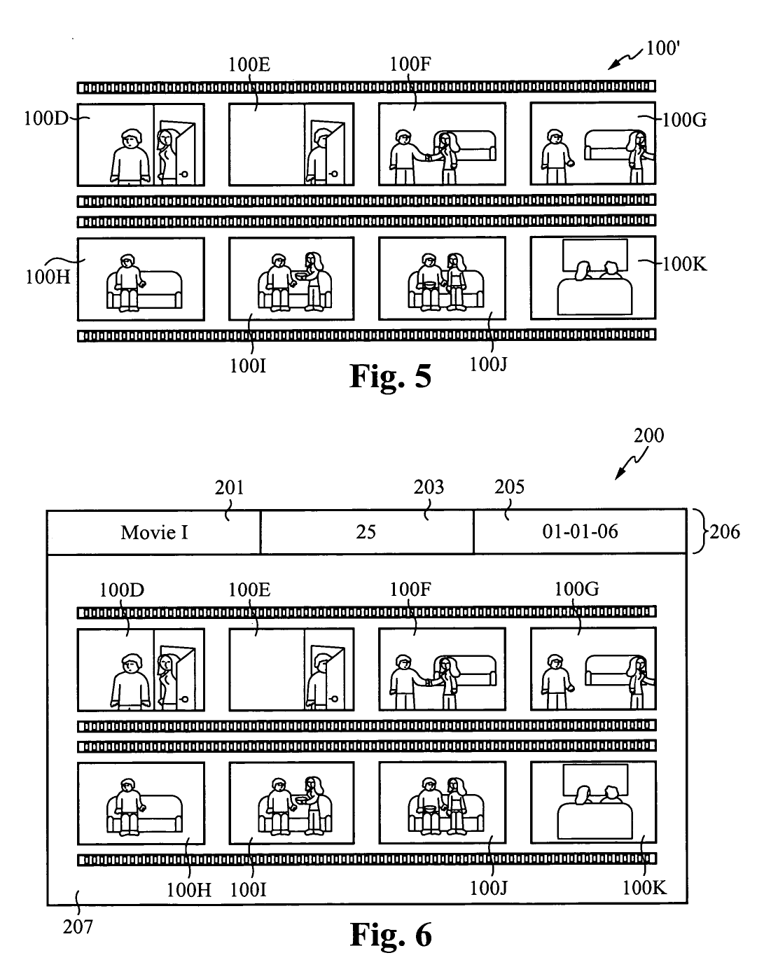

FIG. 5 shows the sequence 100′ of video frames that have been selected using the GUI 170 (FIG. 3) or the GUI 171 (FIG. 4). As explained below, the sequence of video frames 100′ is now packaged to be transmitted to a client system where it can be played by a media player or stored so that it can be later retrieved or played. FIG. 6 shows a container 200 for packaging the sequence 100′ in accordance with one embodiment of the present invention. In one embodiment, the container 200 is in turn packaged in an Internet Protocol (IP) datagram or other message for transmission to a client system using a transmission protocol such as the HyperText Transmission Protocol (HTTP), Real Time Streaming Protocol (“RTSP”), Microsoft Media Server (MMS), or some other transmission protocol.

It will also be appreciated that digital video data can be packaged in many different ways, depending on how and where it is to be transmitted. In the above example, video data is packaged in a container, which is then packaged in an IP datagram for transmission over the Internet. If the video data is to be transmitted to a client system on a local network, it can be packaged in a container, which in turn is packaged in an Ethernet frame for local transmission. If, instead, the video data is to be stored or played locally, dealing with the same host from which a video clip is extracted, the video data can merely be packaged in a container and stored on the client system.

Still referring to FIG. 6, the container 200 contains a header 206 followed by a payload 207. The header 206 includes a title field 201 for the title of the video clip (“Movie I”), a length field 203 for the length of the video clip (“25” minutes), and a date field 205 for the date that the data clip was generated (“Jan. 01, 2006”). It will be appreciated that the header can include metadata other than a title, length, and generation date. The payload 207 contains the sequence of video frames 100′ (FIG. 5). The video frames 100′ are shown as pictures merely for illustration; they are actually stored in the payload 207 as bits.

Referring to FIG. 6, in some embodiments, digital video data for the entire movie “Movie I” is stored in a container with the format of the container 200. A video clip is selected in accordance with the present invention by formatting a new container by (1) updating the value in the length field 203 to indicate the length of the video clip contained in the container 200, (2) updating the date field 205 to indicate the date that the video clip was generated, and (3) populating the payload with the digital video data for the video clip rather than the entire movie.

It will be appreciated that when the video clip is for transmission to a client system, it does not have to be stored in memory in a structure defined by the container 200. Instead, the container 200 merely defines the order in which the data is transmitted to the client system, which can then play it immediately (as part of streaming media) or store it in the structure defined by the container 200.

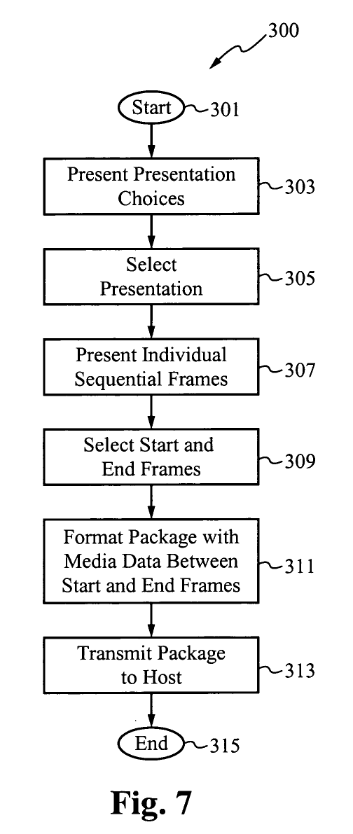

FIG. 7 is a flow chart of the steps for selecting a video clip in accordance with the present invention. Any initialization steps, such as initializing data structures, occur in the start step 301. Next, in the step 303, the user is presented with a list of presentations, from which the user can select video clips. As one example, the user is presented with a list of movies such as “Movie I,” “The Godfather,” and “The Sound of Music.” In the step 305, the user selects a movie, “Movie I.” Referring now to FIGS. 2, 3 and 7, in the step 307, the user is presented with individual video frames 161. In the step 309, the user selects the starting and ending frames (100D and 100K), thereby selecting the video clip. In the step 311, the system formats a data package containing the video clip by storing the video clip in a container (e.g., container 200, FIG. 6) or by transmitting the package in an order defined by a container. In the step 313, the data package is transmitted to the client system and the process ends in the step 315.

It will be appreciated that the steps 300 are exemplary only. For example, if the method of the present invention is used for local playback, then the step 313 is unnecessary.

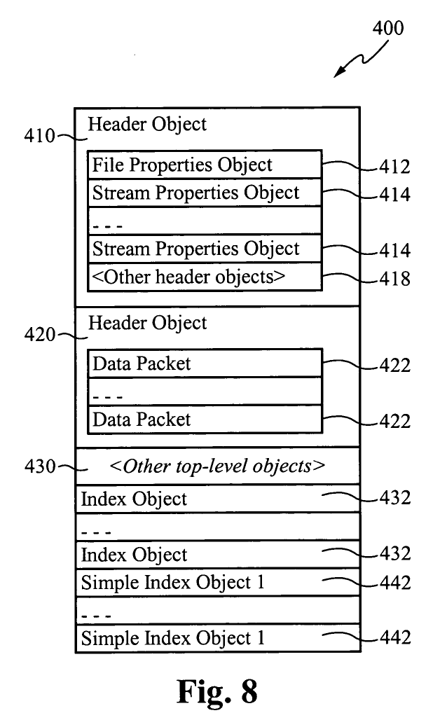

FIG. 8 is a container 400 for encapsulating a selected segment of video data according to Microsoft's Advanced Systems Format (ASF) Specification (Revision Jan. 20, 2003© Microsoft Corporation December 2004) (“ASF Specification”), which is incorporated by reference. ASF, formerly referred to as Advanced Streaming Format, is used to store in a single file any combination of audio data, video data, multi-bit-rate video, metadata, indices, script commands, and the like. ASF specifies structure of a stream and abstracts elements of the stream as objects. ASF does not specify how the video or audio should be encoded, but instead just specifies the structure of the video/audio stream. What this means is that ASF files can be encoded with basically any audio/video codec and still would be in ASF format. The most common filetypes contained within an ASF file are Windows Media Audio (WMA) and Windows Media Video (WMV).

Still referring to FIG. 8, the container 400 contains a Header object 410, a Data object 420, and other top-level objects 430. The Header object 410 includes a block 412 for a File Properties object, one or more blocks 414 for Stream Properties objects, and blocks 418 for other Header objects. The Data object 420 includes one or more data packets 422. The other top-level objects 430 includes one or more Index objects 432 and one or more Simple Index objects 442.

It is important to note that various container formats, other than the ASF format, can be used in accordance with the present invention. ASF is a preferred container format for use in conjunction with the present invention. However, the present invention is not so limited. Other suitable container formats may be used instead.

Table 1 shows pseudocode for serving a video clip using ASF in accordance with embodiments of the present invention. In the example shown in Table 1, a second container for a video clip is derived from a first container for video frames of the entire movie. Table 1 describes steps for populating the second container from the first container. Also, as explained above, when streaming video, the second container merely represents the order that the information in a data package, including the header and video data, are transmitted to the client system.

The pseudocode in Table 1 shows one way to copy digital video data from a first ASF container containing an original video file (such as entire movie) to a second ASF container that contains a segment of the original video file determined by start and end times. The second ASF container is sent using an output stream to a client system.

Several definitions are helpful to understand the pseudocode in Table 1. As explained in the ASF Specification, and illustrated in Table 1, a Header object provides a byte-sequence at the start of an ASF file describing the order of the objects that follow it. It also contains metadata about a video, including the video's author, title, creation date, length, and compression codec. The Properties object contains global file attributes such as a value for the length of the video and a value for the number of data packets. Both of these values are dependent on the size of the segment of the original video media (the video clip). Thus, when an ASF container for a video clip is derived from an ASF container for an entire movie, these values change.

A Data object contains the actual video data, and a Simple Index object contains time-based indices of the video data. The video data is stored in data packets, which are sorted within the Data objects based on the time they are to be sent to a client system.

Preroll is the time that video data should be buffered on the client system before it is played. The Send duration is the time to send the video file in nanosecond units. Index entries are time entries used to index and thus access digital video data within a Data object.

Those skilled in the art will recognize other parameters used in Table 1 and the offsets (e.g., 50 added to the header size to determine the first Packet Address) needed to access elements within the ASF container. Preferably, all videos have one Simple Index Object and the time interval between index entries is one second. The index entries are an array mapping a time in seconds to the packet number of the key frame closest to the time. Because the new video (video clip) has fewer seconds, the number of index entries count are reduced and only those indices that lie within the new time interval are sent.

Time indices correspond to individual video frames, such as the frames 100A-P in FIG. 1. Thus, when a user selects a start frame and an end frame (e.g., 100D and 100K in FIG. 3, respectively), the user also selects a start Time and an end Time, as illustrated in Table 1

```
TABLE 1
Function ServeASFVideo(filename, outputStream, startTime, endTime)
  Where
  filename = path to original video file
  outputStream = data stream to client
  startTime = user-selected time offset into filename (in seconds) to begin video
  endTime = user-selected time offset into filename (in seconds) when video ends
    inputStream = Open filename
    Precompute values
      Seek to ASF_HEADER_OBJECT, and compute
        headerSize = number of bytes in header
      Seek to ASF_File_Properties_Object, and compute
        numPackets = number of data packets in the file
        packetSize = size (in bytes) of every packet (in this embodiment, all packets
        are the same size)
        preRoll = time added to every packet send time
      Seek to ASF_Simple_Index_Object, and compute
        firstPacket = index entries[startTime].Packet Number
        lastPacket = index entries[endTime].Packet Number
      firstPacketAddress = headerSize + 50 + firstPacket * packetSize
      lastPacketAddress = headerSize + 50 + lastPacket * packetSize
      Seek to firstPacketAddress and compute
        firstSendTime = send time of firstPacket
      Seek to lastPacketAddress and compute
        lastSendTime = send time of lastPacket
        lastDuration = duration time of lastPacket
    Seek back to beginning of file
    Send Header Object of the new video to the user
      Copy bytes from position 0 to the beginning of the ASF_File_Properties_Object from
      inputStream to outputStream
      Send new ASF_File_Properties_Object to outputStream, with the same values as the
      original one, except new values for
        File Size = headerSize + (lastPacket − firstPacket) * packetSize + 6 *
        (endTime − startTime + 1) + 56
        Data Packets Count = lastPacket − firstPacket
        Play Duration = lastSendTime + lastDuration − firstSendTime + preRoll
        Send Duration = lastSendTime + lastDuration − firstSendTime
      Copy all bytes from end of ASF_File_Properties_Objects to the beginning of
      ASF_Data_Object from inputStream to outputStream
    Send Data Object of the new video to the client
      Send new Data Object header, with the same values as the original one, except new
      values for
        Object Size = 50 + (lastPacket − firstPacket) * packetSize
        Total Data Packets = lastPacket − firstPacket
      Send new Data Packets
        For all packet indices i between firstPacket and lastPacket
          Address of packet i = headerSize + 50 + i * packetSize
          Seek to address of packet i
          Send packet to outputStream, with the same values as packet i,
          except new values for
            Send Time = original Send Time − firstSendTime
            For each payload, 2nd DWORD in Replication Data
            represents presentation time of payload. System must
            subtract firstSendTime from these values.
    Send Index Object of the new video to the user
      Send new ASF_Simple_Index_Object, with the same values as the original one,
      except new values for
        Object Size = 56 + 6 * (endTime − startTime + 1)
        Index Entries Count = endTime − startTime + 1
        Index Entries = subset of original array corresponding to this time region
```

In some embodiments of the present invention, video clips are stored on a client system and indexed in a directory for easy retrieval. Using the directory, video clips can be easily stored and searched against using search criteria such as any combination of a title of a video clip, a date that it was stored, a number of times it has been played (e.g., the “most popular” video clip), an actor who appears on the video clip, to name a few search criteria. These search criteria can be metadata stored, for example, in the header of a container that holds the video clip.

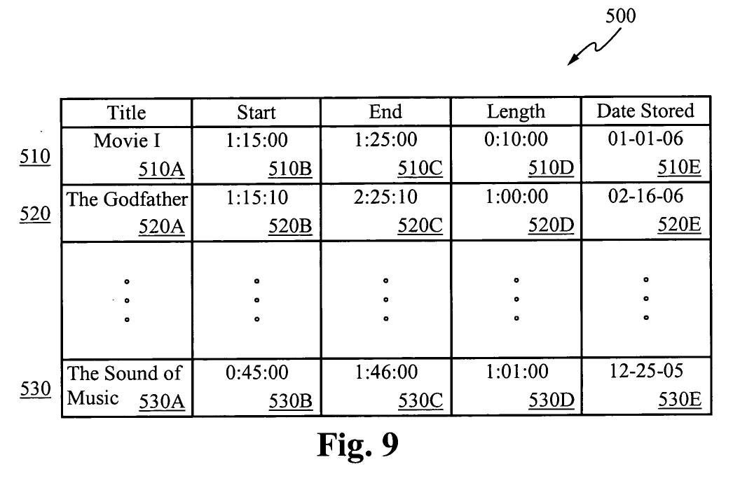

FIG. 9 is a graphical user interface (GUI) 500 showing a directory of video clips generated in accordance with the present invention and stored on a client system. The directory of video clips facilities retrieval of the video segments stored on the client system. The GUI 500 shows a table with columns labeled “Title,” “Start,” “End,” “Length,” and “Date Stored” and rows labeled 510, 520, and 530. The exemplary row 510 contains a field 510A in the “Title” column, a field 510B in the “Start” column, a field 510C in the “End” column, a field 510D in the “Length” column, and a field 510E in the “Date Stored” column. The value “Movie I” in the field 510A indicates that the row contains information for a video clip of the movie “Movie I.” The value “1:15:00” in the field 510B indicates that the video clip begins 1 hour and 15 minutes from the start of the movie and the value “1:25:00” in the field 510C indicates that the video clip ends 1 hour and 25 minutes from the start of the movie. The value “0:10:00” in the field 501D indicates that the video clip is 0 hours, 10 minutes, and 0 seconds long. The value “01-01-06” in the field 510E indicates the date that the video clip was stored on the client system. In one embodiment, the user is able to play the video clip merely by using a mouse to select the field 510A, thereby launching the media player to play the video clip.

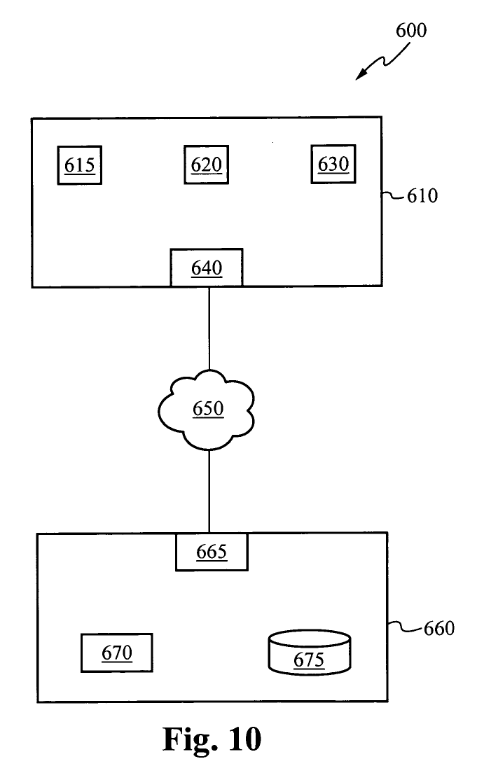

FIG. 10 shows a system 600 for selecting video clips in accordance with one embodiment of the present invention. The system 600 comprises a server 610 coupled to a client system 660 over the Internet 650. The server 610 includes a presentation module 615, a selection module 620, a formatting module 630, and a transmission module 640. The client system 660 includes a Web browser module 665, a media player 670, and a storage module 675. The Web browser module 665 includes a transmission module for communicating with the transmission module 640, such as by using HTTP or RTSP.

As one example, in operation, a user on the client system 660 uses the Web browser module 665 to access the server 610. The presentation module 615 presents the user with a list of movies. From the list, the user selects a movie, “Movie I,” and the selection module presents the user with a sequence of frames from “Movie I” and controls for selecting start and end times of the movie clip. It will be appreciated that the user could select the entire movie by selecting as the start time the start of the entire movie and as the end time the end of the entire movie. When the user initiates a transmission, by for example selecting a send button (e.g., 162, FIG. 3), the formatting module 630 populates a container with the video clip, and the transmission module 640 packages the container in a IP datagram and transmits the IP datagram over the Internet 650 to the transmission module 665. The user can then selectively play the video clip using the media player 670, or the user can store the video clip on the storage module 675 and index it so that it can be listed in, searched for, and retrieved through a directory.

It will be appreciated that while the examples above describe video clips, the present invention is also useful for selecting segments of other media, such as audio, animation, live events, and the like. It will also be appreciated that embodiments of the present invention can be used to determine fees charged for selecting and transmitting video clips. As one example, a fee charged for selecting and transmitting video clips is based on the length of a video clip. Thus, the fee charged to a user on a client system for transmitting a 2 hour video is $1.00. A user who selects a 1 hour segment of the video, in this example, and downloads it is charged (½) $1.00, or 50 cents. It will be appreciated that other formulas can be used to determine fees charged for selecting video and other media clips in accordance with the present invention.

Preferably, the components 615, 620, 630, 640, 665, and 670 are implemented in software. Each of the components 615, 620, 630, 640, 665, and 665 are stored on computer-readable media, such as compact discs or computer hard-drives, and can be combined in many ways. For example, the components 615, 620, and 630 can be implemented as a single computer program, as multiple computer programs linked together, or as separate programs that communicate using shared memory, messages, and the like.

It will be readily apparent to one skilled in the art that various other modifications may be made to the embodiments without departing from the spirit and scope of the invention as defined by the appended claims.

What is claimed is:

1. A method of serving media comprising:
selecting a segment of a block of media data;
formatting a data package containing the selected segment for playing on a media player; and
transmitting the data package to a client system.

2. The method of claim 1, wherein the transmitting of the data package forms streaming media.

3. The method of claim 1, further comprising playing the selected segment on a media player on the client system.

4. The method of claim 1, wherein the data package is formatted according to Advanced Systems Format.

5. The method of claim 1, wherein the data package is transmitted to the client system according to HyperText Transfer Protocol.

6. The method of claim 1, wherein the block of media data corresponds to one of audio data, video data, audio/video data, and animation data.

7. The method of claim 1, wherein selecting the segment of the block of media data comprises selecting start and end frames from multiple frames that correspond to the block of media.

8. The method of claim 7, wherein the start and end frames are selected using a graphical user interface.

9. The method of claim 1, further comprising determining a cost of transmitting the data package, wherein the cost is based on a size of the selected segment.

10. The method of claim 1, further comprising determining a cost of transmitting the data package, wherein the cost is based on a relation between a size of the selected segment and a size of the block of media data.

11. A method of managing media data comprising:
selecting a segment from a block of media data;
formatting a data package containing the segment for playing on a media player; and
storing the data package on a client system.

12. The method of claim 11, wherein formatting the data package comprises generating a header corresponding to the selected segment.

13. The method of claim 12, wherein the header comprises metadata.

14. The method of claim 13, wherein the metadata comprises any one or more of a title, an artist, a movie classification, and a song classification.

15. The method of claim 11, wherein the data package is formatted using Advanced Systems Format.

16. The method of claim 13, further comprising performing a search for the formatted data package based on at least a portion of the metadata.

17. A system for processing media data comprising:
a server for selecting a segment of a block of media data, encapsulating the selected data segment, and transmitting the encapsulated data segment over a transmission medium; and
a client system for receiving and playing the encapsulated data segment.

18. The system of claim 17, wherein the client system comprises a media player.

19. The system of claim 17, wherein the client system comprises a Web browser for communicating with the server for selecting the segment.

20. The system of claim 17, wherein the server comprises a presentation module and a selection module, wherein the presentation module is for presenting multiple media files and the selection module is for selecting a segment from one of the multiple media files.

21. The system of claim 20, wherein the media data are audio/video data and the selection module presents video frames corresponding to scenes from one of the multiple media files.

22. The system of claim 21, wherein each of the video frames is a thumbnail video frame.

23. The system of claim 17, wherein the selection module comprises a graphical user interface.

24. The system of claim 23, wherein the selection module is configured to select frames corresponding to the segment using drag-and-drop.

25. The system of claim 23, wherein the selection module is configured to select frames corresponding to the segment using a radio button.

26. The system of claim 17, wherein the media data are any one of video data, audio data, audio/video data, and animation data.

27. The system of claim 17, wherein the server and the client system are configured to communicate according to HyperText Transfer Protocol.

28. The system of claim 19, wherein the server is configured to encapsulate the selected data segment according to Advanced Systems Format.

29. A system for processing media data comprising:
means for selecting a segment of a block of media data;
means for encapsulating the selected data segment; and
means for transmitting the encapsulated data segment over a transmission medium to a client system configured to receive and rendering the encapsulated data segment.

30. A computer-readable medium having computer executable instructions for performing a method comprising:
selecting a segment of a media block; and
formatting a data packet containing the selected segment for playing on a media player.

31. The computer-readable medium of claim 30, wherein the method further comprises sending the formatted data packet over a transmission medium to a client system.

32. The computer-readable medium of claim 30, wherein the data package is formatted according to Advanced Systems Format.

33. The computer-readable medium of claim 31, wherein the data package is transmitted to the client system according to HyperText Transfer Protocol.

34. The computer-readable medium of claim 30, wherein the method further comprises searching for the segment of media block using search criteria, the search criteria including meta data corresponding to the segment of the media block.

35. The computer-readable medium of claim 30, wherein the block of media data corresponds to one of audio data, video data, audio/video data, and animation data.

36. The computer-readable medium of claim 30, wherein selecting the segment of the media block comprises selecting start and end frames from the media block.

37. The computer-readable medium of claim 30, wherein the segment of a media block is selected using a graphical user interface.
